(19) United States
(12) Patent Application Publication
(10) Pub. No.: US 2016/0269689 A1
(43) Pub. Date: Sep. 15, 2016

(54) SYSTEM AND METHOD FOR PROVIDING CCTV INFORMATION

(71) Applicant: Thinkware Corporation, Seognam-si (KR)

(72) Inventors: Ji Woong PARK, Seoul (KR); Won Dal JANG, Seongnam-si (KR); Yoo Jung WON, Yongin-si (KR); Kyung Min LEE, Seongnam-si (KR); Seong Ho KIM, Suwon-si (KR); Dong Hwi LIM, Seoul (KR); Dae Cheol KIM, Seoul (KR)

(21) Appl. No.: 14/831,392

(22) Filed: Aug. 20, 2015

(30) Foreign Application Priority Data
Mar. 13, 2015 (KR) 10-2015-0035303
Jun. 2, 2015 (KR) 10-2015-0078234

(51) Int. Cl. H04N 7/18

(52) U.S. Cl. CPC H04N 7/181

(57) ABSTRACT

Provided is a system and method for providing closed circuit television (CCTV) information. A method configured as a computer may include generating and managing relevant information between a CCTV and a road route, receiving information about a course from an electronic device over a network, verifying a road route present in the received course, and verifying a CCTV present in the verified road route based on the relevant information, assigning an order associated with a heading direction of the course to CCTV information about the verified CCTV based on the relevant information, and transmitting the CCTV information to which the order is assigned, to the electronic device. Here, the CCTV information may be arranged based on the assigned order and displayed on a screen of the electronic device.

### CROSS-REFERENCE TO RELATED APPLICATION

This application claims the priority benefit of Korean Patent Application No. 10-2015-0035303, filed on Mar. 13, 2015, and Korean Patent Application No. 10-2015-0078234, filed on Jun. 2, 2015 in the Korean Intellectual Property Office, the disclosure of each is incorporated herein by reference.

### BACKGROUND

1. Field of the Invention

The following description relates to technology for providing closed circuit television (CCTV) information and more particularly, to a system and method for guiding a CCTV in a navigation system.

2. Description of Related Art

Some related art discloses technology for providing closed circuit television (CCTV) information. For example, when a CCTV icon is displayed on a map and a user selects the CCTV icon, a CCTV image of a location corresponding to the selected CCTV icon is provided. Alternatively, CCTV screens presented in a selected road are provided or a CCTV image adjacent on a course is provided while driving. Korean Patent Publication No. 10-2010-0097779 discloses technology that classifies regional traffic information based on a region unit, registers and manages the classified regional traffic information using a database server, receives coordinate information and navigation terminal information based on a set communication protocol, extracts a traffic image within a desired (or alternatively predetermined) distance from the database server based on the coordinate information, and provides the extracted traffic image to a navigation terminal.

As described above, in the related art, individual image information about an adjacent CCTV while driving is provided or CCTV images about preset main roads are provided. Accordingly, to acquire information about a CCTV corresponding to a desired course, for example, a course to a desired destination of a user, the user is to individually search for and to verify information about the CCTV corresponding to the desired course or to verify a CCTV image while directly driving along the course. For example, the user is to individually search for and verify each of CCTV images present in the desired course.

### SUMMARY

Embodiments provide a system and method that may provide a view, for example, a screen through which a user is capable of intuitively verifying a plurality of closed circuit television (CCTV) images present in a desired course at a time.

Embodiments also provide a system and method that may effectively provide a plurality of CCTV images set by a user and relevant information although a course is not input.

According to an aspect, there is provided a method configured as a computer, the method includes generating and managing relevant information between a CCTV and a road route, receiving information about a course from an electronic device over a network, verifying a road route present in the received course, and verifying a CCTV present in the verified road route based on the relevant information, assigning an order associated with a heading direction of the course to CCTV information about the verified CCTV based on the relevant information, and transmitting the CCTV information to which the order is assigned, to the electronic device. Here, the CCTV information is arranged based on the assigned order and displayed on a screen of the electronic device.

The CCTV information transmitted to the electronic device may include CCTV identification information and a thumbnail image corresponding to a CCTV image, and the CCTV identification information and the thumbnail image correspond to each other, and may be arranged based on the assigned order and displayed on the screen of the electronic device.

A map screen or a course guide screen may be displayed on the electronic device, and the CCTV information transmitted to the electronic device may be arranged on a vertical column based on the assigned order and is displayed on one side of the map screen or the course guide screen.

A function of selecting at least one CCTV information to which the order is assigned and a detour search function associated with the selected at least one CCTV information may be provided from the electronic device, and the method may further include searching for a new course that avoids a road route corresponding to the selected at least one CCTV information and providing the found new course to the electronic device, in response to a request of the electronic device generated through the detour search function.

A user interface for requesting a CCTV image may be displayed on the screen of the electronic device, and the verification may include verifying a CCTV present in a road route associated with a current location of the electronic device or a road route associated with a CCTV selected by a user based on the relevant information in response to a request generated at the electronic device through the user interface, when the request includes information about the road route associated with the current location of the electronic device or the road route associated with the selected CCTV, and the assigning of the order may include assigning an order associated with a heading direction of the road route to the verified CCTV.

A user interface that enables a user to select a plurality of CCTVs regardless of a course may be displayed on the screen of the electronic device, and the verification may include verifying the plurality of CCTVs selected by the user in response to a request generated at the electronic device through the user interface, and the assignment of the order may include assigning an order to each of the verified CCTVs in order in which the plurality of CCTVs is selected by the user.

A user interface for displaying information about a CCTV of a congested area in the CCTV information to which the order is assigned may be displayed on the screen of the electronic device, and the verification may include verifying information about the CCTV of the congested area in the CCTV information to which the order is assigned, in response to a request generated at the electronic device through the user interface.

According to another aspect, there is provided a method configured as a computer, the method includes setting a course based on information input from a user, transmitting information about the set course to a server over a network, receiving CCTV information about a CCTV to which an order is assigned, from the server, and arranging the received CCTV information based on the assigned order and displaying the received CCTV information on a screen. At the server, relevant information between a CCTV and a road route may be generated and managed, a road route present in the course may be verified based on information about the set course, a CCTV present in the verified road route may be verified based on the relevant information, an order associated with a heading direction of the course may be assigned to CCTV information about the verified CCTV based on the relevant information, and the CCTV information to which the order is assigned may be provided.

According to still another aspect, there is provided a system including one or more processors, wherein the one or more processors include a relevant information manager configured to generate and manage relevant information between a CCTV and a road route, a course information receiver configured to receive information about a course from an electronic device over a network, a CCTV verifier configured to verify a road route present in the received course, and to verify a CCTV present in the verified road route based on the relevant information, an order assigner configured to assign an order associated with a heading direction of the course to CCTV information about the verified CCTV based on the relevant information, and a transmitter configured to transmit the CCTV information to which the order is assigned, to the electronic device. Here, the CCTV information may be arranged based on the assigned order and displayed on a screen of the electronic device.

According to still another aspect, there is provided a system including one or more processors, wherein the one or more processors include a course setter configured to set a course based on information input from a user, a course information transmitter configured to transmit information about the set course to a server over a network, a CCTV information receiver configured to receive CCTV information about a CCTV to which an order is assigned, from the server, and a graphics processor configured to arrange the received CCTV information based on the assigned order and display the received CCTV information on a screen. At the server, relevant information between a CCTV and a road route may be generated and managed, a road route present in the course may be verified based on information about the course, a CCTV present in the verified road route may be verified based on the relevant information, an order associated with a heading direction of the course may be assigned to CCTV information about the verified CCTV based on the relevant information, and the CCTV information to which the order is assigned may be provided.

### Effects

According to embodiments, it is possible to provide a view, for example, a screen through which a user is capable of intuitively verifying a plurality of closed circuit television (CCTV) images present in a desired course at a time.

Also, according to embodiments, it is possible to effectively provide a plurality of CCTV images set by a user and relevant information although a course is not input.

### BRIEF DESCRIPTION OF THE DRAWINGS

These and/or other aspects, features, and advantages of the disclosure will become apparent and more readily appreciated from the following description of embodiments, taken in conjunction with the accompanying drawings of which:

FIG. 1 is a diagram illustrating an example of an operating environment of a system for providing closed circuit television (CCTV) information according to an embodiment;

FIG. 2 is a block diagram illustrating a configuration of an electronic device and a server according to an embodiment;

FIG. 3 is a block diagram illustrating a configuration of a processor included in a server according to an embodiment;

FIG. 4 is a flowchart illustrating a method performed at a server to provide CCTV information according to an embodiment;

FIG. 5 is a block diagram illustrating a processor included in an electronic device according to an embodiment;

FIG. 6 is a flowchart illustrating a method performed at an electronic device to provide CCTV information according to an embodiment;

FIG. 7 illustrates an example of a screen on which a user interface for requesting displaying of CCTV information is displayed according to an embodiment;

FIG. 8 illustrates an example of a screen on which CCTV information is displayed in response to an input of a user through a user interface according to an embodiment;

FIG. 9 illustrates an example of a screen on which CCTV information present in a set course is displayed according to an embodiment;

FIG. 10 illustrates an example of a screen on which information about a CCTV selected by a user is displayed according to an embodiment; and

FIG. 11 illustrates an example of a screen on which information about a CCTV present in a course is displayed according to an embodiment.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

Hereinafter, embodiments will be described with reference to the accompanying drawings.

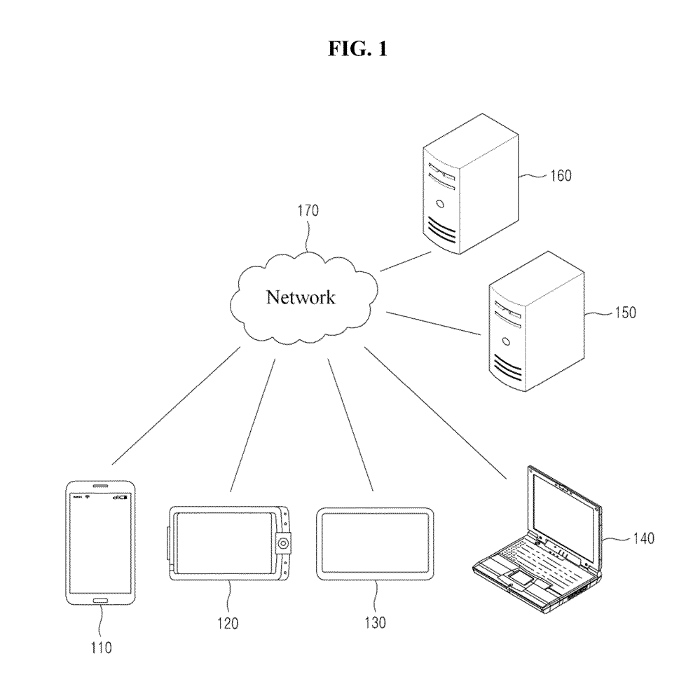

FIG. 1 is a diagram illustrating an example of an operating environment of a system for providing closed circuit television (CCTV) information according to an embodiment. The operating environment of the system according to the embodiment may include electronic devices 110, 120, 130, and 140, servers 150 and 160, and a network 170.

The electronic devices 110, 120, 130, and 140 may be fixed terminals or mobile terminals. For example, an electronic device may be a smartphone, a mobile phone, a navigation terminal, a computer, a laptop computer, a digital multimedia broadcasting (DMB) terminal, a personal digital assistant (PDA), a portable multimedia player (PMP), and a tablet personal computer (PC). Each of the electronic devices 110, 120, 130, and 140 may communicate with another electronic device and/or the servers 150 and 160 over the network 170 in a wireless or wired communication manner.

A communication method is not limited and may include a communication method using a communication network, for example, a mobile communication network, the wired Internet, the wireless Internet, and a broadcasting network, which is includable in the network 170, and near field radio communication between devices.

The network 170 may include at least one of networks, for example, a personal area network (PAN), a local area network (LAN), a campus area network (CAN), a metropolitan area network (MAN), a wide area network (WAN), a broadband network (BBN), and the Internet. In addition, the network 170 may include at least one of network topologies that include a bus network, a star network, a ring network, a mesh network, a star-bus network, and a tree or hierarchical network, however, is not limited thereto.

Each of the servers 150 and 160 may be configured as one or more apparatuses that provide content for a CCTV information providing service by communicating with the electronic devices 110, 120, 130, and 140 over the network 170. The servers 150 and 160 may constitute a single system to provide a CCTV information providing service or may be individual systems that provide different services, respectively. For example, the server 150 may be a server that provides a CCTV image, and the server 160 may be a server that generates content for a CCTV information providing service by processing the CCTV image provided from the server 150 and provides the generated content to the electronic devices 110, 120, 130, and 140.

In response to a user request through the electronic devices 110, 120, 130, and 140, the servers 150 and 160 may provide codes capable of configuring screens of the electronic devices 110, 120, 130, and 140 to the electronic devices 110, 120, 130, and 140, and may configure screens based on codes provided using programs included in the electronic devices 110, 120, 130, and 140. Through this, the servers 150 and 160 may provide content to users.

Hereinafter, various embodiments will be described based on a single electronic device 110 and a single server 150 that provides a CCTV information providing service to the electronic device 110.

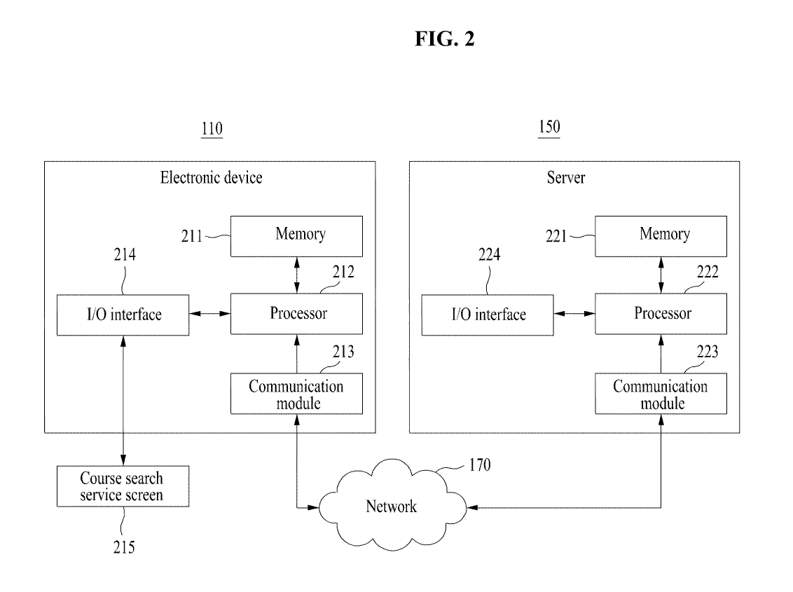

FIG. 2 is a block diagram illustrating a configuration of an electronic device and a server according to an embodiment. The electronic device 110 may include a memory 211, a processor 212, a communication module 213, and an input/output (I/O) interface 214. The server 150 may also include a memory 221, a processor 222, a communication module 223, and an I/O interface 224. The memories 211 and 221 may include a permanent mass storage device, such as a random access memory (RAM), a real only memory (ROM), and a disc drive, as computer-readable storage media. Also, an operating system (OS) and at least one program code may be stored in the memories 211 and 221. For example, at least one program code included in the memory 221 of the server 150 may include a code for controlling the processor 222 to generate content for providing a CCTV image and to transmit the content to the electronic device 110, in response to a request of the electronic device 110. Also, at least one program code included in the memory 211 of the electronic device 110 may include a code for controlling the processor 212 to request the content for providing a CCTV image to the server, to receive the content for providing the CCTV image from the server 150, and to provide the content to a user.

Such software constituent elements may be loaded from another computer-readable storage medium separate from the memories 211 and 221 using a drive mechanism (not shown). The other computer-readable storage medium may include, for example, a floppy drive, a disc, a tape, a DVD/CD-ROM drive, and a memory card. Software constituent elements may be loaded to the memories 211 and 221 through the communication modules 213 and 223 instead of using the computer-readable storage medium. For example, the at least one program code may be loaded to the memories 211 and 221 based on programs installed by files provided from developers over the network 170.

The processors 212 and 222 may be configured to process computer-readable instructions of a computer program by performing a basic calculation, a logic, and an input/output operation. The computer-readable instructions may be provided from the memories 211 and 221 or the communication modules 213 and 223 to the processors 212 and 222. The processors 212 and 222 may be configured to execute program codes stored in storage devices such as the memories 211 and 221.

The communication modules 213 and 223 may provide a function of communicating with another device over the network 170, for example, communicating with the server 150 in view of the electronic device 110 and communicating with the electronic device 110 in view of the server 150. For example, a request message generated at the processor 212 according to a control of the user may be transferred to the server 150 over the network 170 according to a control of the communication module 213. In this example, the server 150 may receive the request message through the communication module 223 and may process the received request message through the processor 222. Conversely, the server 150 may transmit content corresponding to the request message to the electronic device 110 through the communication module 223 and the network 170.

The I/O interface 214 may provide a function of connecting to an I/O device that is further included in the electronic device 110 or connectable to the electronic device 110. Similarly, the I/O interface 224 may provide a function of connecting to an I/O device that is further included in the server 150 or connectable to the server 150. A mouse, a keyboard, a touch panel, and a microphone may be included as examples of an input device, and a speaker, a display, and a touch screen may be included as examples of an output device. For example, a course search service screen 215 configured according to processing of the processor 212 may be displayed on a display connected to the electronic device 110 through the I/O interface 214.

Also, according to other embodiments, the electronic device 110 and the server 150 may include a more number of constituent elements than the number of constituent elements of FIG. 2. However, many conventional constituent elements are not required to be clearly illustrated. For example, the electronic device 110 may further include other constituent elements, for example, a display such as a touch screen, a transceiver, and a global positioning system (GPS) module.

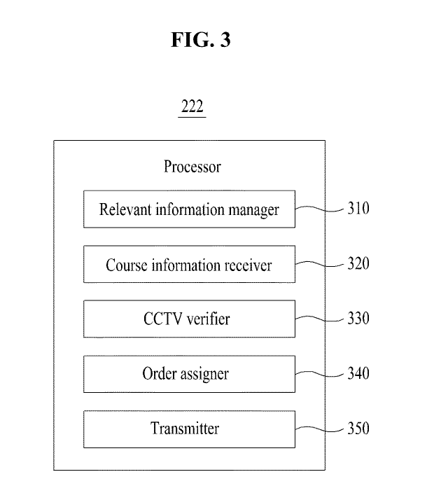

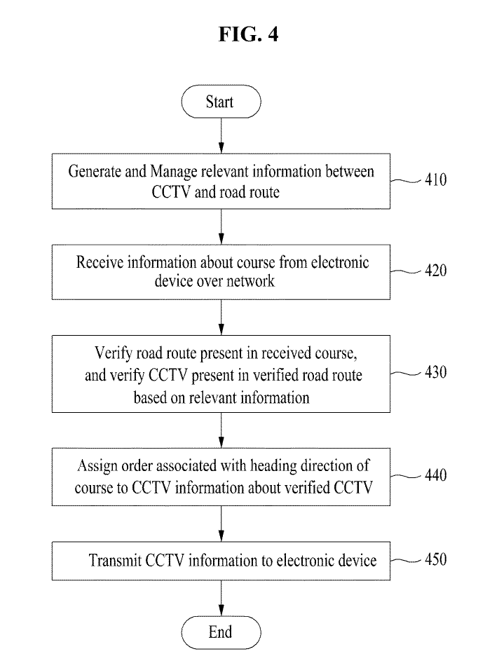

FIG. 3 is a block diagram illustrating a configuration of a processor included in a server according to an embodiment, and FIG. 4 is a flowchart illustrating a method performed at a server to provide CCTV information according to an embodiment. Referring to FIG. 3, the processor 222 included in the server 150 may include a relevant information manager 310, a course information receiver 320, a CCTV verifier 330, an order assigner 340, and a transmitter 350. The constituent elements may be configured to perform operations 410 through 450 of FIG. 4 through an OS and at least one program code included in the memory 221.

In operation 410, the relevant information manager 310 may generate and manage relevant information between a CCTV and a road route. For example, a CCTV having an identifier of “AA” is present in “Expressway AA”, the CCTV “AA” and the road route “Expressway AA” may have a mutual correlation there between. In this example, the relevant information manager 310 may generate and manage, as relevant information in association with the CCTV “AA” and “Expressway AA”, location information such as a latitude and a longitude of the CCTV “AA” and direction information regarding whether a direction in which the CCTV “AA” takes recording is up or down of the Expressway “AA”.

In operation 420, the course information receiver 320 may receive information about a course from the electronic device 110 over a network. The electronic device 110, as an entity that requests a CCTV image, may transmit information about a course input from or set by the user to the server 150 and the course information receiver 320 may receive information about the course transmitted over the network, for example, the network 170 of FIG. 3, from the electronic device 110.

In operation 430, the CCTV verifier 330 may verify a road route present in the received course, and may verify a CCTV present in the verified road route based on the relevant information. For example, one or more road routes may be present in a single course. The CCTV verifier 330 may verify road routes present in the course and may verify CCTVs present in the verified road routes based on the relevant information generated and managed in operation 410.

In operation 440, the order assigner 340 may assign an order associated with a heading direction of the course to CCTV information about the verified CCTV based on the relevant information. As described above, since the relevant information includes information about a location or a recording direction of a CCTV, orders of road routes included in the course and orders of CCTVs in the course may be verified and the order associated with the heading direction of the course may be assigned to each CCTV based on the verified orders.

In operation 450, the transmitter 350 may transmit the CCTV information to which the order is assigned to the electronic device 110. Here, the CCTV information may be arranged based on the assigned order and displayed on a screen of the electronic device 110.

Accordingly, the user of the electronic device 110 may verify a plurality of pieces of CCTV information about CCTVs present in a course set by the user at a time, in order associated with the heading direction of the course. Thus, the user may easily verify information, such as a CCTV image corresponding to a desired course, without verifying individual CCTVs.

In detail, CCTV information transmitted to the electronic device 110 may include CCTV identification information, a thumbnail image corresponding to a CCTV image, and travel speed information of vehicles measured by analyzing the CCTV image. Here, the electronic device 110 may arrange, based on the assigned order, and display, on the screen, the CCTV identification information, the thumbnail image, and the travel speed information to correspond to one another.

The electronic device 110 may display a map screen or a course guide screen. Here, the CCTV information may be arranged on a vertical column based on the assigned order and may be displayed on one side of the map screen or the course guide screen.

The provided CCTV information may be used to avoid a congested area. For example, the electronic device 110 may provide a function of selecting at least one CCTV information to which the order is assigned and a detour search function associated with the selected at least one CCTV information. A request generated at the electronic device 110 may be transmitted to the server 150 using the detour search function of the user. In this example, although not illustrated, the method of FIG. 4 may further include an operation of searching for a new course that avoids a road route corresponding to the selected at least one CCTV information and providing the found new course to the electronic device 110, in response to a request of the electronic device 110 through the detour search function. This operation may be performed by a course searcher (not shown) that may be further included in the processor 222.

Also, it is possible to provide information about CCTVs associated with a current location of the electronic device 110 or information about CCTVs set or selected by the user through a single view or a single screen, regardless of a set course.

For example, a user interface for requesting a CCTV image may be displayed on the screen of the electronic device 110. In this example, in operation 430, the CCTV verifier 330 may receive a request generated at the electronic device 110 through the user interface, and when the request includes information about a current location of the electronic device 110 or a CCTV selected by the user, may verify a road route associated with the current location of the electronic device 110 or a road route associated with the selected request, and may verify a CCTV present in the verified road route based on relevant information. In this case, in operation 440, the order assigner 340 may assign an order associated with a heading direction of the road route to the verified CCTV. Similarly, the CCTV information to which the order is assigned may be transmitted to the electronic device 110, and the electronic device 110 may arrange the CCTV information based on the assigned order and may display the arranged CCTV information on the screen. Accordingly, the user may obtain CCTV images corresponding to a current road route or a road route associated with the selected CCTV at a time through a one-time selection, for example, a touch and a click, on the user interface, for example, a CCTV icon.

As another example, a user interface that enables the user to select a plurality of CCTVs regardless of a course may be displayed on the screen of the electronic device 110. In this example, in operation 430, the CCTV verifier 330 may receive a request generated at the electronic device 110 through the user interface and may verify the plurality of CCTVs selected by the user. In this case, in operation 440, the order assigner 340 may assign an order to each of the CCTVs in order in which the plurality of CCTVs is selected by the user. The CCTV information to which the order is assigned may be transmitted to the electronic device 110, and the electronic device 110 may arrange the CCTV information based on the assigned order and may display the arranged CCTV information on the screen. Accordingly, the user may obtain information, for example, images of the CCTVs selected by the user, at a time.

In addition, it is possible to display only information about a CCTV of a congested area. For example, a user interface for displaying information about the CCTV of the congested area in the CCTV information to which the order is assigned may be displayed on the screen of the electronic device 110. When the user selects the user interface, a request for displaying only information about the CCTV of the congested area may be transmitted to the server 150. In this case, the CCTV verifier 330 may verify information about the CCTV of the congested area in the CCTV information to which the order is assigned in response to the request generated at the electronic device 110 through the user interface. The verified information may be transmitted to the electronic device 110 and the electronic device 110 may display only information about the CCTV of the congested area on the screen.

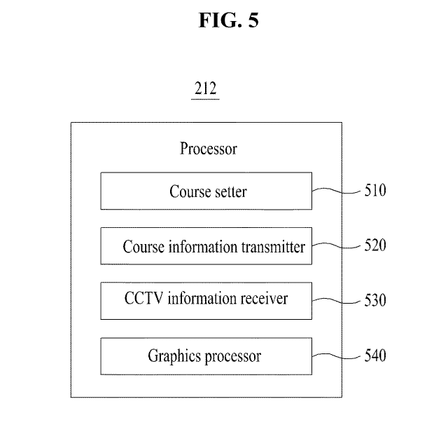

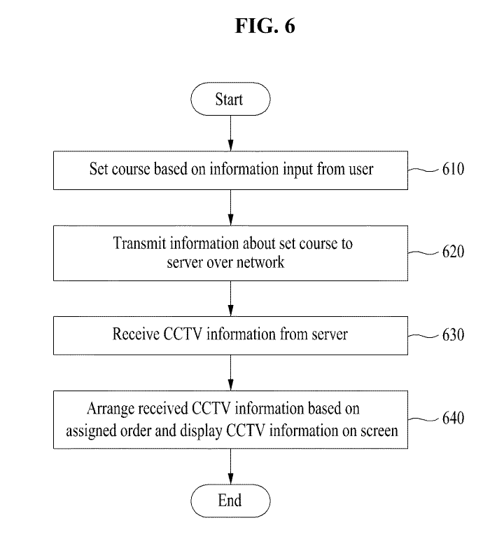

FIG. 5 is a block diagram illustrating a processor included in an electronic device according to an embodiment, and FIG. 6 is a flowchart illustrating a method performed at an electronic device to provide CCTV information according to an embodiment. Referring to FIG. 5, the processor 212 included in the electronic device 110 may include a course setter 510, a course information transmitter 520, a CCTV information receiver 530, and a graphics processor 540. The constituent elements may be configured to perform operations 610 through 640 of FIG. 6 through an OS and at least one program code included in the memory 211.

In operation 610, the course setter 510 may set a course based on information input from a user. A variety of methods that enable a user to set a course are known in the field of a map service or a course guide service. Accordingly, a detailed description related to a course setting method is omitted.

In operation 620, the course information transmitter 520 may transmit information about the set course to the server 150 over a network. As described above, the server 150 may generate and manage relevant information between a CCTV and a road route. In addition, the server 150 may verify a road route present in the course based on information about the set course, may verify a CCTV present in the verified road route based on the relevant information, may assign an order associated with a heading direction of the course to CCTV information about the verified CCTV, and may provide the CCTV information to which the order is assigned.

In operation 630, the CCTV information receiver 530 may receive the CCTV information to which the order is assigned, from the server 150. The server 150 may transmit the CCTV information to which the order is assigned to the electronic device 110 over a network, for example, the network 170, and the CCTV information receiver 530 may receive the CCTV information transmitted from the server 150.

In operation 640, the graphics processor 540 may arrange the received CCTV information based on the assigned order and may display the CCTV information on a screen. Accordingly, the user may verify information about a CCTV present in a desired course at a time in order associated with a heading direction of the course. Here, the screen may correspond to a screen of a display that is further included in the electronic device 110 or connected to the electronic device 110.

As described above, according to an embodiment, the received CCTV information may include CCTV identification information and a thumbnail image corresponding to a CCTV image. Speed information of vehicles included in the CCTV image may also be displayed on the thumbnail image. Here, in operation 640, the graphics processor 540 may arrange, based on the assigned order, and display, on the screen, the CCTV identification information and the thumbnail image that correspond to each other.

According to another embodiment, in operation 640, the graphics processor 540 may display a map screen or a course guide screen and may arrange the received CCTV information on a vertical column based on the assigned order and display the received CCTV information on one side of the map screen or the course guide screen.

The user may use the CCTV information displayed on the screen to avoid a congested area. For example, although not illustrated, the method of FIG. 6 may further include an operation of providing a function of selecting at least one CCTV information to which the order is assigned and a detour search function associated with the selected at least one CCTV information. This operation may be performed by a detour search function provider (not shown) that may be further included in the processor 212. In this instance, the course information transmitter 520 may further transmit a request generated using the detour search function to the server 150. In response to the request, the server 150 may search for a new course that avoids a road route corresponding to the selected at least one CCTV information and may provide the found new course. The electronic device 110 may provide a map service or course guide service screen according to the provided new course.

As described above, it is possible to provide information about CCTVs associated with a current location of the electronic device 110 or information about CCTVs set or selected by the user through a single view, for example, a single screen, regardless of a set course.

To this end, the graphics processor 540 may display a user interface for requesting a CCTV image. In this example, although not illustrated, the method of FIG. 6 may further include an operation of requesting a CCTV image associated with a current location or a CCTV selected by the user to the server 150 in response to an input of the user through the user interface. This operation may be performed by a CCTV image requester (not shown) that may be further included in the processor 212. In this case, the server 150 may verify a CCTV present in a road route associated with the current location or a road route associated with the selected CCTV based on relevant information, may assign an order associated with a heading direction of the road route to CCTV information about the verified CCTV, and may provide the CCTV information to which the order is assigned. The CCTV information provided to the electronic device 110 may be arranged based on the assigned order and may be displayed on the screen.

As another example, the graphics processor 540 may display a user interface that enables the user to select a plurality of CCTVs regardless of a course. In this example, although not illustrated, the method of FIG. 6 may further include an operation of requesting a CCTV image associated with the selected plurality of CCTVs to the server in response to an input of the user through the user interface. This operation may be performed by the CCTV image requester (not shown). In this case, the server 150 may assign an order to each of the CCTVs in which the plurality of CCTVs is selected by the user, and may provide the CCTV information to which the order is assigned. Even in this case, the CCTV information provided to the electronic device 110 may be arranged based on the assigned order and may be displayed on the screen.

Also, the electronic device 110 may display only information about a CCTV of a congested area. For example, the graphics processor 540 may further display, on the screen, a user interface of displaying information about the CCTV of the congested area in the CCTV information to which the order is assigned. In this example, when the user selects the user interface, a request for information about the CCTV of the congested area may be transmitted to the server 150. In response to the request generated at the electronic device 110 through the user interface, the server 150 may search for information about the CCTV of the congested area and may provide the found information.

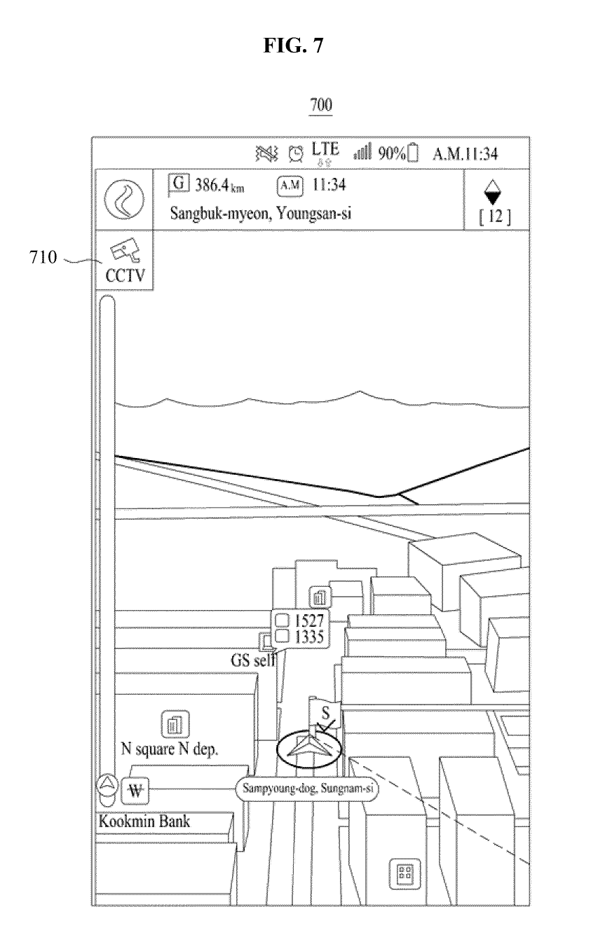

FIG. 7 illustrates an example of a screen on which a user interface for requesting displaying of CCTV information is displayed according to an embodiment. A first screen 700 represents a screen example of the electronic device 110 in which a user interface 710 for requesting CCTV information is displayed on a course guide screen. When the user selects the user interface 710, for example, when the user touches an area on which the user interface 710 is displayed in a touch screen environment or clicks on the area in a PC environment, the server 150 may receive the request for CCTV information.

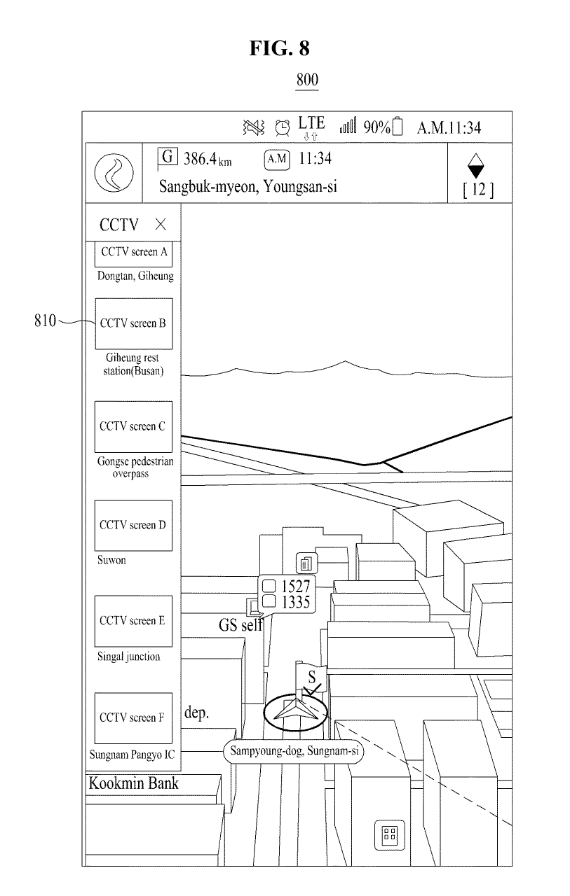

FIG. 8 illustrates an example of a screen on which CCTV information is displayed in response to an input of a user through a user interface according to an embodiment. A second screen 800 represents an example of a screen of the electronic device 110 on which CCTV information 810 provided from the server 150 is displayed in response to the user selecting the user interface 710. The CCTV information 810 may be arranged in order according to a variety of embodiments. As described above, the displayed CCTV information 810 may be arranged based on an order assigned to a CCTV of a set course in association with a heading direction of the course, may be arranged based on an order assigned to a CCTV of a road route associated with a current location of the electronic device 110 in association with a heading direction of the road route, or may be arranged in order in which each of the CCTVs is selected by the user.

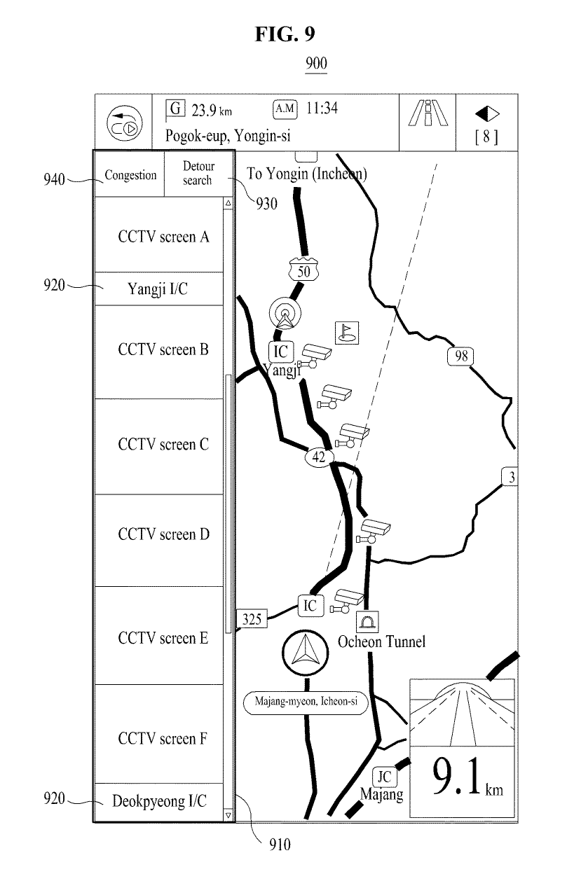

FIG. 9 illustrates an example of a screen on which CCTV information present in a set course is displayed according to an embodiment. A third screen 900 represents an example of a screen of the electronic device 110 on which information 910 about CCTVs present in a set course is displayed based on an order associated with a heading direction of the course. For example, when the user sets the course using a function of an application installed in the electronic device 110 and selects the user interface 710 of FIG. 7, images of CCTVs present in the set course may be provided together with relevant information thereof. The relevant information may include information 920 about an interchange or a junction.

Also, the third screen 900 represents an example of providing a detour search function 930. When the detour search function 930 is activated, a new course that avoids a road route corresponding to information about the selected CCTV may be found and provided through the server 150. The new course that avoids the route road may be found using one of the known methods.

Also, the third screen 900 represents an example of providing a user interface 940 capable of verifying only information about a CCTV of a congested area. When the user selects the user interface 940, only information about the CCTV of the congested area in the

CCTV information may be verified and may be displayed through the server 150

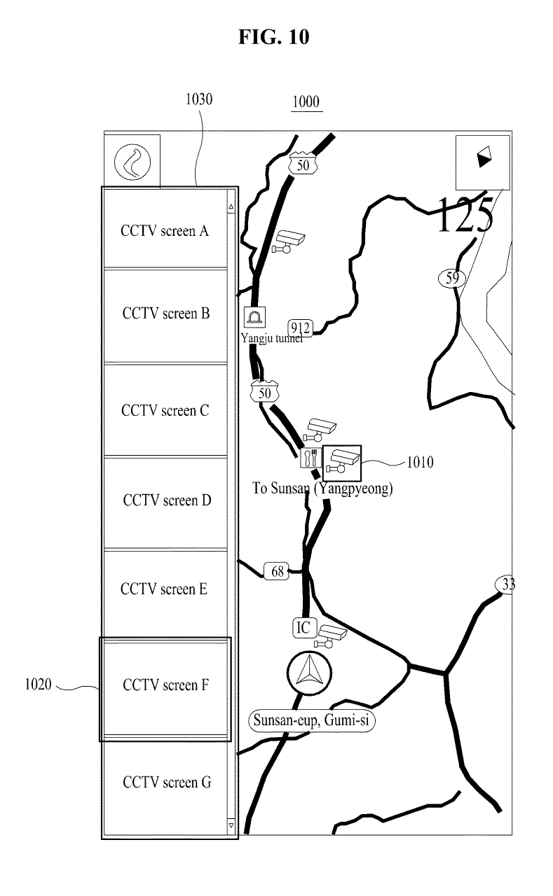

FIG. 10 illustrates an example of a screen on which information about a CCTV selected by a user is displayed according to an embodiment. A fourth screen 1000 represents an example of a screen on which the user selects a desired CCTV by selecting a CCTV icon 1010 displayed on a map, and information 1020 about the selected CCTV is displayed. In this example, information 1030 about all of the CCTVs present in a road route in which the selected CCTV is located may also be displayed. In FIG. 10, when the user selects the CCTV icon 1010 on the fourth screen 1000, only information 1020 about the selected CCTV may be displayed. Alternatively, information 1030 about all of the CCTVs may be displayed. When information 1030 about all of the CCTVs present in the road route is displayed, the information 1030 may be visually processed so that the information 1020 about the CCTV corresponding to the selected CCTV icon 1020 may be distinguished from information about other CCTVs. For example, the information 1020 may be displayed to be distinguished from other information by highlighting an outline of the information 1020, and by alternatively, displaying the information 1020 using a flickering method.

The information 1030 may express information about a maximum number of CCTVs displayable on the screen of the electronic device 1010. When the user moves a course on the map, CCTV locations may vary based on the course. Accordingly, the information 1030 to be displayed may vary.

Table 1 shows an example of relevant information generated and managed by the server 150.

TABLE 1

| | | | | Direc- |
|---|---|---|---|---|
| Point | Route | Latitude | Longitude | tion |
| Hasangok | Tongyoung | 37.5097199991 | 127.22583 | Up |
| | Daejeon Jungbu | | | |
| | Expressway (35) | | | |
| Sangsang- | Tongyoung | 37.4937553227 | 127.2372552142 | Up |
| okkyo | Daejeon Jungbu | | | |
| | Expressway (35) | | | |
| Guri | Beltway around | 37.6155976378 | 127.1412691336 | Up |
| | Seoul (100) | | | |
| Toegyewon | Beltway around | 37.6394399991 | 127.13361 | Up |
| | Seoul (100) | | | |
| Cheonggye- | Beltway around | 37.3947199991 | 127.02722 | Up |
| unjunggyo | Seoul (100) | | | |
| Cheonggye | Beltway around | 37.3933299991 | 1237.0015648428 | Down |
| sales office | Seoul (100) | | | |
| Hakui | Beltway around | 37.602222222222 | 127.15361111111 | Down |
| junction | Seoul (100) | | | |

In Table 1, the point refers to a location at which a CCTV is installed and may indicate an identifier of the CCTV, and the route may indicate a road route in which the CCTV is present. The server 150 may generate and manage relevant information, and may determine orders of CCTVs present in a course based on the relevant information.

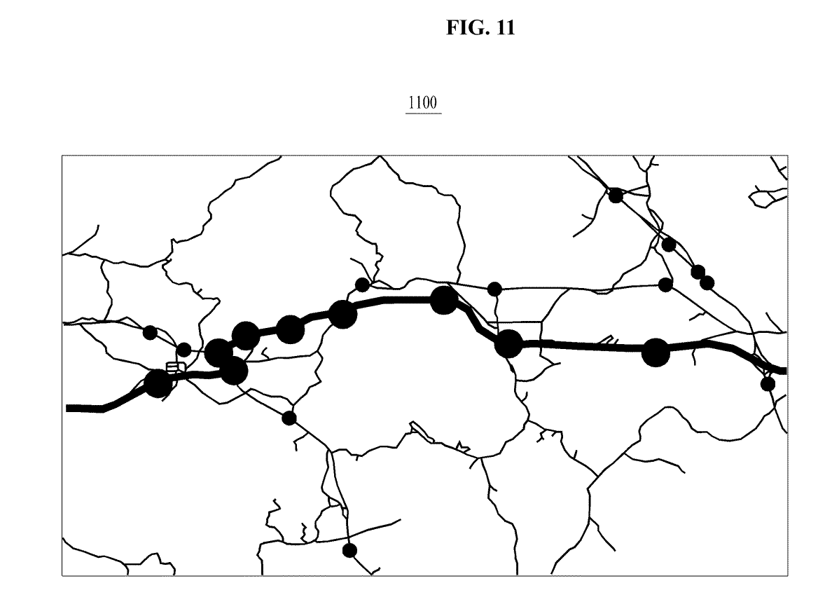

FIG. 11 illustrates an example of a screen on which information about a CCTV present in a course is displayed according to an embodiment. The server 150 may verify CCTVs present in a course, based on information about the course received from the electronic device 110. A screen 1100 represents an example of displaying CCTVs verified by the server 150 on a map on which a course is marked. The server 150 may assign an order associated with a heading direction of the course to each of the CCTVs, and the electronic device 110 may arrange and display CCTV information about the CCTVs, based on the assigned order. Here, the CCTV information may include, for example, a CCTV image that selectively includes a CCTV identifier, an interchange, and a junction.

According to embodiments, it is possible to provide a view, for example, a screen through which a user is capable of intuitively verifying a plurality of CCTV images present in a desired course at a time. Further, it is possible to effectively provide a plurality of CCTV images set by a user and relevant information although a course is not input.

Although an example in which a server provides a user with a CCTV image present in a course is described, it is only an example. In addition to the CCTV image, an image taken from a drone, an image taken from a helicopter, and images taken by users using a digital camera, a car video recorder, and the like may be provided to an electronic device. In this example, when a thumbnail image of a taken image, for example, the image taken from the drone, the image taken from the helicopter, and the images taken by the users using the digital camera, the car video recorder, and the like, is provided to the electronic device of the user, and is selected by the user, the server may provide the user with a video associated with the selected thumbnail image.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device(s) configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device(s) may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, and/or computer storage medium or device. The software also may be distributed over network coupled computer systems so that the software is stored and executed in a distributed fashion. The software and data may be stored by one or more computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

Although a few embodiments of the present disclosure have been shown and described, the present disclosure is not limited to the described embodiments. Instead, it would be appreciated by those skilled in the art that changes may be made to these embodiments without departing from the principles and spirit of the disclosure, the scope of which is defined by the claims and their equivalents.

What is claimed is:

1. A method configured as a computer, the method comprising:
generating and managing relevant information between a closed circuit television (CCTV) and a road route;
receiving information about a course from an electronic device over a network;
verifying a road route present in the received course, and verifying a CCTV present in the verified road route based on the relevant information;
assigning an order associated with a heading direction of the course to CCTV information about the verified CCTV based on the relevant information; and
transmitting the CCTV information to which the order is assigned, to the electronic device,
wherein the CCTV information is arranged based on the assigned order and displayed on a screen of the electronic device.

2. The method of claim 1, wherein the CCTV information transmitted to the electronic device comprises CCTV identification information and a thumbnail image corresponding to a CCTV image, and
the CCTV identification information and the thumbnail image correspond to each other, and are arranged based on the assigned order and displayed on the screen of the electronic device.

3. The method of claim 1, wherein a map screen or a course guide screen is displayed on the electronic device, and
the CCTV information transmitted to the electronic device is arranged on a vertical column based on the assigned order and is displayed on one side of the map screen or the course guide screen.

4. The method of claim 1, wherein a function of selecting at least one CCTV information to which the order is assigned and a detour search function associated with the selected at least one CCTV information are provided from the electronic device, and the method further comprises:
searching for a new course that avoids a road route corresponding to the selected at least one CCTV information and providing the found new course to the electronic device, in response to a request of the electronic device generated through the detour search function.

5. The method of claim 1, wherein a user interface for requesting a CCTV image is displayed on the screen of the electronic device, and
the verifying comprises verifying a CCTV present in a road route associated with a current location of the electronic device or a road route associated with a CCTV selected by a user based on the relevant information in response to a request generated at the electronic device through the user interface, when the request comprises information about the road route associated with the current location of the electronic device or the road route associated with the selected CCTV, and
the assigning of the order comprises assigning an order associated with a heading direction of the road route to the verified CCTV.

6. The method of claim 1, wherein a user interface that enables a user to select a plurality of CCTVs regardless of a course is displayed on the screen of the electronic device, and
the verifying comprises verifying the plurality of CCTVs selected by the user in response to a request generated at the electronic device through the user interface, and
the assigning of the order comprises assigning an order to each of the verified CCTVs in order in which the plurality of CCTVs is selected by the user.

7. The method of claim 1, wherein a user interface for displaying information about a CCTV of a congested area in the CCTV information to which the order is assigned is displayed on the screen of the electronic device, and
the verifying comprises verifying information about the CCTV of the congested area in the CCTV information to which the order is assigned, in response to a request generated at the electronic device through the user interface.

8. A method configured as a computer, the method comprising:
setting a course based on information input from a user;
transmitting information about the set course to a server over a network;
receiving closed circuit television (CCTV) information about a CCTV to which an order is assigned, from the server; and
arranging the received CCTV information based on the assigned order and displaying the received CCTV information on a screen,
wherein at the server, relevant information between a CCTV and a road route is generated and managed, a road route present in the course is verified based on information about the set course, a CCTV present in the verified road route is verified based on the relevant information, an order associated with a heading direction of the course is assigned to CCTV information about the verified CCTV based on the relevant information, and the CCTV information to which the order is assigned is provided.

9. The method of claim 8, wherein the received CCTV information comprises CCTV identification information and a thumbnail image corresponding to a CCTV image, and
the displaying comprises arranging, based on the assigned order, and displaying, on the screen, the CCTV identification information and the thumbnail image that correspond to each other.

10. The method of claim 8, wherein the displaying comprises displaying a map screen or a course guide screen, and arranging the received CCTV information on a vertical column based on the assigned order and displaying the received CCTV information on one side of the map screen or the course guide screen.

11. The method of claim 8, further comprising:
providing a function of selecting at least one CCTV information to which the order is assigned and a detour search function associated with the selected at least one CCTV information, and
the transmitting comprises further transmitting a request generated through the detour search function to the server, and
at the server, a new course that avoids a road route corresponding to the selected CCTV information is found and provided in response to the request.

12. The method of claim 8, wherein the displaying comprises displaying a user interface for requesting a CCTV image, and the method further comprises:
requesting a CCTV image associated with a current location or a CCTV selected by the user to the server in response to an input of the user through the user interface, and
at the server, a CCTV present in a road route associated with the current location or a road route associated with the selected CCTV is verified based on the relevant information, and an order associated with a heading direction of the road route is assigned to the verified CCTV.

13. The method of claim 8, wherein the displaying comprises displaying a user interface that enables a user to select a plurality of CCTVs regardless of a course, and the method further comprises:
requesting CCTV images of the selected plurality of CCTVs to the server in response to an input of the user through the user interface,
wherein at the server, an order is assigned to each of the CCTVs in order in which the plurality of CCTVs is selected by the user.

14. The method of claim 8, wherein the displaying comprises further displaying, on the screen, a user interface of displaying information about a CCTV of a congested area in the CCTV information to which the order is assigned, and
at the server, information about the CCTV of the congested area in the CCTV information to which the order is assigned is found and provided in response to a request generated through the user interface.

15. A non-transitory computer-readable recording medium storing a program to implement the method of claim 1.

16. A system comprising one or more processors, wherein the one or more processors comprise:
a relevant information manager configured to generate and manage relevant information between a closed circuit television (CCTV) and a road route;
a course information receiver configured to receive information about a course from an electronic device over a network;
a CCTV verifier configured to verify a road route present in the received course, and to verify a CCTV present in the verified road route based on the relevant information;
an order assigner configured to assign an order associated with a heading direction of the course to CCTV information about the verified CCTV based on the relevant information; and
a transmitter configured to transmit the CCTV information to which the order is assigned, to the electronic device,
wherein the CCTV information is arranged based on the assigned order and displayed on a screen of the electronic device.

17. The system of claim 16, wherein the CCTV information transmitted to the electronic device comprises CCTV identification information and a thumbnail image corresponding to a CCTV image, and
the CCTV identification information and the thumbnail image correspond to each other, and are arranged based on the assigned order and displayed on the screen of the electronic device.

18. The system of claim 16, wherein a map screen or a course guide screen is displayed on the electronic device, and
the CCTV information transmitted to the electronic device is arranged on a vertical column based on the assigned order and is displayed on one side of the map screen or the course guide screen.

19. A system comprising one or more processors, wherein the one or more processors comprise:
a course setter configured to set a course based on information input from a user;
a course information transmitter configured to transmit information about the set course to a server over a network;
a closed circuit television (CCTV) information receiver configured to receive CCTV information about a CCTV to which an order is assigned, from the server; and
a graphics processor configured to arrange the received CCTV information based on the assigned order and display the received CCTV information on a screen, and
at the server, relevant information between a CCTV and a road route is generated and managed, a road route present in the course is verified based on information about the course, a CCTV present in the verified road route is verified based on the relevant information, an order associated with a heading direction of the course is assigned to CCTV information about the verified CCTV based on the relevant information, and the CCTV information to which the order is assigned is provided.

20. The system of claim 19, wherein the received CCTV information comprises CCTV identification information and a thumbnail image corresponding to a CCTV image, and
the graphics processor is further configured to arrange, based on the assigned order, and display, on a screen, the CCTV identification information and the thumbnail image that correspond to each other .
